(19) United States
(12) Patent Application Publication
(10) Pub. No.: US 2002/0091470 A1
(43) Pub. Date: Jul. 11, 2002

(54) Control equipment and method for controlling an electric car

(75) Inventors: Kazuyoshi Sasazawa, Hitachinaka-shi (JP); Eiichi Ohtsu, Mito-shi (JP); Sanshiro Obara, Naka-gun (JP); Nobunori Matsudaira, Hitachi-shi (JP)

Correspondence Address: CROWELL & MORING, L.L.P., P.O. Box 14300, Washington, DC, 20044-4300, US

(73) Assignee: Hitachi, Ltd.

(21) Appl. No.: 10/046,751

(22) Filed: Jan. 17, 2002

Related U.S. Application Data
(63) Continuation of application No. 09/196,113, filed on Nov. 20, 1998, now abandoned.

(30) Foreign Application Priority Data
Nov. 20, 1997 (JP) 9-320099

(51) Int. Cl. B60L 11/00

(52) U.S. Cl. 701/22; 701/29; 180/65.1

(57) ABSTRACT

Control equipment for an electric car and a control method thereof can be realized with control equipment for an electric car mounted with a plurality of rotating machines equipped with a plurality of microcomputers for individually controlling each rotating machine with a simple configuration in such a manner as to enable diagnosis of abnormalities of the control equipment to a high degree of precision. The plurality of microcomputers for individually controlling each rotating machine at the control equipment of the electric car comprise a control data calculator for generating control data for controlling respective target rotating machines and a fault diagnosis module for transmitting and receiving the control data to and from another microcomputer as control data for diagnosis use via a communication device, comparing the control data and the control data for diagnosis use, and diagnosing the presence or absence of a fault. An electric car comprising a plurality of microcomputers, e.g. a microcomputer for an engine assistant motor for controlling an engine assistant motor and a microcomputer for controlling a motor for driving an auxiliary machine, for example, can then be made to have a function for carrying out mutual monitoring using these microcomputers.

### BACKGROUND OF THE INVENTION

The present invention relates to control equipment for an electric car mounted with a plurality of rotating machines such as motors and generators and a control method thereof, and more particularly relates to a diagnostic module for control equipment equipped with microcomputers for individually controlling each rotating machine.

With related technology for control equipment for electric cars, as disclosed, for example, in Japanese Patent Laid-open Publication No. Hei. 5-122801, that where exchange of data between a microcomputer for motor control and a microcomputer for vehicle control is carried out, arithmetic processing is mutually monitored and wild running of a Central Processing Unit (CPU) is prevented is well known. According to the control equipment disclosed in this publication, means of transmitting and receiving rotational speed of a motor and a torque reference is provided between two CPU's. The two microcomputers are then made to operate in synchronism, data is transmitted and received, mutual monitoring is carried out and abnormalities are sensed.

Further, in Japanese Patent Laid-open Publication No. Hei. 8-182103, there is disclosed that where in order to detect errors in two microcomputers, outputs of first and second controllers are compared, and when errors that are equal to or greater than a prescribed value continue for a prescribed period of time, the occurrence of an error in the two microcomputers is determined and a fail safe signal is outputted.

However, this doubling of the number of microcomputers complicates the equipment configuration and control method. Further, with the technology disclosed in Japanese Patent Laid-open Publication No. Hei. 5-122801, since it is necessary to make two microcomputers that fundamentally do not necessarily operate together operate in synchronism, complicated synchronization processing is therefore required in order to synchronize the arithmetic processing of the two microcomputers that do not necessarily carry out the same processes, and the configuration therefore becomes complex.

When an abnormality occurs at the control equipment, considering that a current reference value and a current value for this current reference value do not necessarily coincide, even if a torque reference that does not always correlate with current for driving a motor and a rotational speed of the motor are transmitted and received, control equipment abnormalities are not always detected and abnormality sensing performance of the control apparatus can not always be made high.

On the other hand, with hybrid electric cars that have recently come to the forefront, there has been disclosed that provided with a plurality of microcomputers such as a microcomputer for controlling an engine auxiliary motor sometimes serving also as a generator for driving drive wheels of an electric car and a microcomputer for controlling a motor for driving auxiliary machines such as air conditioners etc.

With electric cars mounted with a plurality of rotating machines such as motors and generators and equipped with a plurality of microcomputers for individually controlling each rotating machine, pairing of microcomputers for mutuallyu monitoring arithmetic processing of each microcomputer as in the related art makes the overall configuration complex and increases costs.

### SUMMARY OF THE INVENTION

It is therefore the object of the present invention to realize control equipment for an electric car and a control method thereof for an electric car equipped with a plurality of microcomputers for individually controlling a plurality of rotating machines that is simple in configuration while being capable of diagnosing faults in control equipment to a high degree of accuracy.

In the present invention, with control equipment for an electric car mounted with a plurality of rotating machines and equipped with microcomputers for individually controlling each said rotating machine, each microcomputer comprises a control data calculator and a fault diagnosis module. The control data calculator is for generating control data for controlling each respective rotating machine to be controlled. The fault diagnosis module is for transmitting and receiving the control data to and from another microcomputer as control data for diagnosis use via a communication control device, comparing the control data and the control data for diagnosis use, and diagnosing the presence or absence of a fault.

According to the present invention, by providing a communication control device between a plurality of microcomputers for individually controlling rotating machines to be controlled and transmitting and receiving control data for diagnosis use, and then comparing control data generated within each microcomputer and transmitted and received control data for diagnosis use, diagnosis of abnormalities of control equipment for an electric car can be carried out. Namely, with an electric car equipped with microcomputers for individually controlling a plurality of rotating machines, e.g. a microcomputer for controlling an engine auxiliary motor and a microcomputer for controlling the motor for driving an auxiliary machine, the microcomputers are given a function for carrying out mutual monitoring. The overall configuration of the control equipment for the electric car can therefore be simplified and reliability of the control equipment can be improved without increasing costs.

In a further feature of the present invention, with control equipment for an electric car mounted with a plurality of rotating machines and being equipped with microcomputers for individually controlling each rotating machine, each microcomputer comprises a plurality of control data calculators for generating control data for controlling each respective rotating machine to be controlled and generating data for controlling rotating machines to be controlled by another microcomputer as control data for diagnosis use, a communication control device for transmitting an interrupt signal to any of the plurality of control data calculator and carrying out data communication between said plurality of control data calculating means via communication means; and fault diagnosis means for comparing said control data generated by each microcomputer with said control data for diagnosis generated by said other microcomputer and diagnosing the presence or absence of a fault, wherein said plurality of control data calculating means transmit and receive said control data for diagnosis use in synchronism with said interrupt signal.

According to the present invention, when control data for diagnostic use is sent to from the transmission side control means to the communication control device, transmitting and receiving of control data for diagnosis use can be put into synchronism by transmitting an interrupt signal to the receiving side control means. In this way, transmitting and receiving of data can be carried out even if the control data calculating means of each microcomputer do not themselves operate in synchronism.

With this control equipment for an electric car, process timing of the control data calculator is divided between a switching period of electrical power converter connected across each said rotating machine and a power supply and a period depending on dynamic characteristics of an electric car driver. As a result, as it is not necessary to perform operations with all the plurality of processes all in synchronism, the overall processing does not become complex even with fault diagnosis means added.

Further, with this control equipment for an electric car, the transmitted and received control data for diagnosis use is a current reference value for current flowing at the rotating machine, a current sense value for current flowing at the rotating machine and a phase angle of said rotating machine.

In this way, by taking a sense value of current flowing at a rotating machine and a phase angle of a rotating machine as control data for diagnosis to be transmitted and received, carrying out comparisons within each microcomputer and making a determination by comparing a current reference value and a current sense value, abnormalities can be detected in entire control equipment including microcomputers and sensors even when there is no abnormality in a reference value.

In a further feature of the present invention, a communication means is equipped with bi-directional communication memory. Overall processing therefore does not become complex even when three or more microcomputers for individually controlling each rotating machine are provided.

### BRIEF DESCRIPTION OF THE DRAWINGS

FIG. 1 shows the basic configuration of a first embodiment of an electric car and control equipment thereof occurring in the present invention.

FIG. 2 shows processing functions of the microcomputer for engine assistant motor use of FIG. 1 using blocks.

FIG. 3 shows the processing functions of the microcomputer for auxiliary machine driving motor use of FIG. 1 using blocks.

FIG. 4 is a structural view of the control equipment of FIG. 1 showing processing contents using function blocks.

FIG. 5 is a structural view of control equipment of an electric car in a second embodiment of the present invention showing processing contents using function blocks.

FIG. 6 is a flowchart showing an example of processing for transmitting and receiving of data between a microcomputer for engine assistant motor use and a microcomputer for auxiliary machine driving motor use using the communication means, occurring in a second embodiment of the present invention.

FIG. 7 is a flowchart showing the sequence for transmitting and receiving data using the communication means shown in FIG. 6.

FIG. 8 shows the operating period of the microcomputer for engine assistant motor use of the present invention.

FIG. 9 shows using function blocks the processing contents of electric car control equipment equipped with three or more microcomputers of a third embodiment of the present invention.

### DESCRIPTION OF THE PREFERRED EMBODIMENTS

A description of a first embodiment of the present invention is now described based on the drawings.

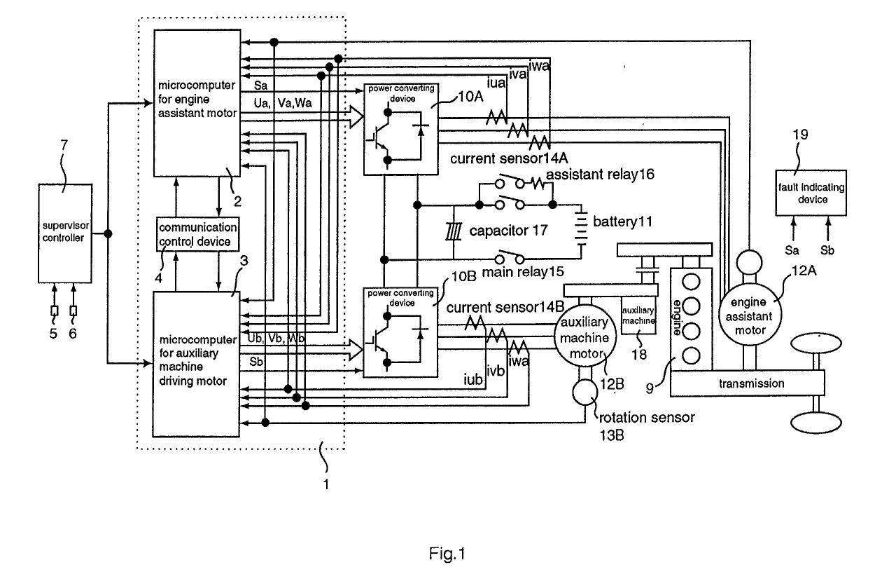

FIG. 1 is a view showing the basic configuration of control equipment for an electric car of the present invention. In FIG. 1, a microcomputer 2 for an engine assistant motor and a microcomputer 3 for an auxiliary machine driving motor are built-in at electric car control equipment 1, with a communication control device 4 being arranged between the microcomputer 2 and the microcomputer 3. Operating references for each motor corresponding to an accelerator stroke signal and shift position signal from acceleration equipment 5 and shift equipment 6 are inputted to the microcomputer 2 and the microcomputer 3 from the supervisor controller 7.

The microcomputer 2 converts the calculated current reference value to a current and outputs this current to a power converting device 10A so as to control an engine assistant motor 12A. Further, the microcomputer 3 outputs the calculated current reference value to a power converting device 10B so as to carry out control of a auxiliary machine motor 12B.

The engine assistant motor 12A provides auxiliary driving under prescribed conditions to drive wheels of an electric car normally driven by an engine 9. For example, when the vehicle is setting off, i.e. when the speed is in the range of 0 to 20 Km/h, an operation reference is received from the supervisor controller 7, the microcomputer 2 controls the driving power of the engine assistant motor 12A and the drive wheels of the electric car are driven. When the speed exceeds 20 Km/h, the accelerator stroke signal is monitored and when the extent to which the axle is opened is large, the engine assistant motor 12A assists the rotation of the engine 9. When the vehicle then reduces speed, the engine assistant motor 12A functions as a generator, retarding energy is converted to electrical energy by the regenerative operation and the battery is recharged.

The auxiliary machine motor 12B receives a rotation speed instruction from the supervisor controller 7, rotates at a fixed speed and drives auxiliary machines 18 such as a compressor for air conditioning, etc.

Rotation of the engine assistant motor 12A is sensed by a rotation sensor 13A and a rotation sense signal is transmitted to the microcomputer 2 and the microcomputer 3. On the other hand, rotation of the auxiliary machine motor 12B is also detected by a rotation sensor 13B and a rotation sense signal is transmitted to the microcomputer 3 and the microcomputer 2. The number of rotations and phase of the motors 12A and 12B within the microcomputer 2 and the microcomputer 3 can then be calculated using these signals.

Currents (iua, iva, iwa, iub, ivb, iwb) suppled to the motors 12A and 12B are detected by current sensors 14A and 14B. The detected currents are then inputted to both the microcomputer 2 and the microcomputer 3 as current sense signals. At the microcomputer 2 and the microcomputer 3, calculation of voltage instructions (Vua*, Vva*, Vwa*, Vub*, Vwb*) is carried out at a current control calculator for controlling the current flowing at the motors 12A and 12B based on the inputted current sense signals, instructions outputted from the supervisor controller 7 are received and voltage instructions Ua, Va, Wa and Ub, Vb and Wb are transmitted to the power converting devices (inverters) 10A and 10B.

At the power converting devices 10A and 10B a power semiconductor element is driven based on the current reference value signal and electrical power from the battery 11 is converted into alternating current and supplied to the motors 12A and 12B. The motors 12A and 12B then generate driving power using electrical power supplied via the power converting devices 10A and 10B and the electric car and auxiliary machine are driven.

Fault analysis processing for both of the microcomputers and the rotation sensors etc. is also carried out at the microcomputer 2 and the microcomputer 3. A fault signal Sa or Sb is then outputted when it is determined that there is a fault of some kind and processing is carried out to display a fault at a fault indicating device 19 and halt operation of the power converting devices 10A and 10B.

The microcomputer 2 and the microcomputer 3 consists of RAM for storing programs for executing prescribed processing, CPU's for executing prescribed processing in accordance with program procedures and ROM for storing data relating to processing, etc.

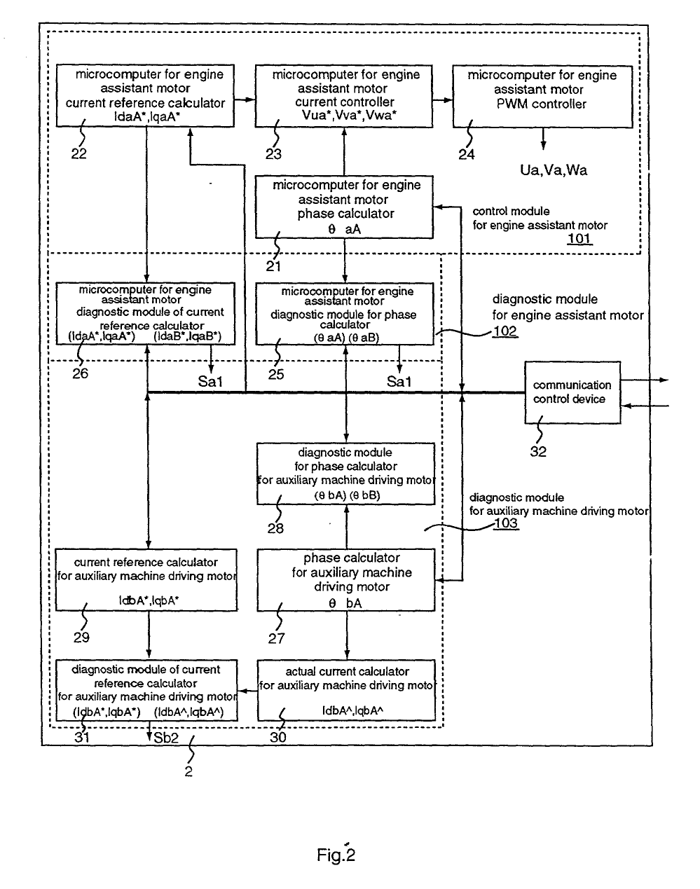

FIG. 2 is a block diagram showing an outline of processing functions carried out at the microcomputer 2. The microcomputer 2 is equipped with a control module 101 for the engine assistant motor, a diagnostic module 102 for the engine assistant motor 102, a diagnostic module for auxiliary machine driving motor 103 and a communication control device 32 for executing communication processing relating to each process.

The control module 101 for the engine assistant motor comprises a phase calculator 21 for calculating the rotational phase angle (θaA) of the engine auxiliary motor, a current reference calculator 22 for carrying out current reference calculations (IdaA*, IqaA*) for the engine auxiliary motor, a current controller 23 for carrying out current control calculations for the engine auxiliary motor and a PWM controller 24 for converting current reference values to electrical power based on the calculation results for the current control device for outputting to the power converting device 10A.

The diagnostic module 102 for the engine assistant motor comprises a diagnostic module for phase calculator 25 relating to engine auxiliary motor calculations and a diagnostic module of current reference calculator 26 relating to current reference calculations for the engine auxiliary motor.

The diagnostic module 103 for the auxiliary machine driving motor comprises a phase calculator 27 for calculating the rotational phase angle (θbA) of the auxiliary machine driving motor, a diagnostic module 28 for phase calculation relating to calculations of the auxiliary machine driving motor phase angle, a current reference calculator 29 for carrying out current reference (IdbA*, IqbA*) calculations for the auxiliary machine driving motor, an actual current calculator 30 for calculating the actual current (IdbA*, IqbA*) of the auxiliary machine driving motor, and diagnostic module of current reference calculator 31 relating to actual current with respect to the current reference of the auxiliary machine driving motor.

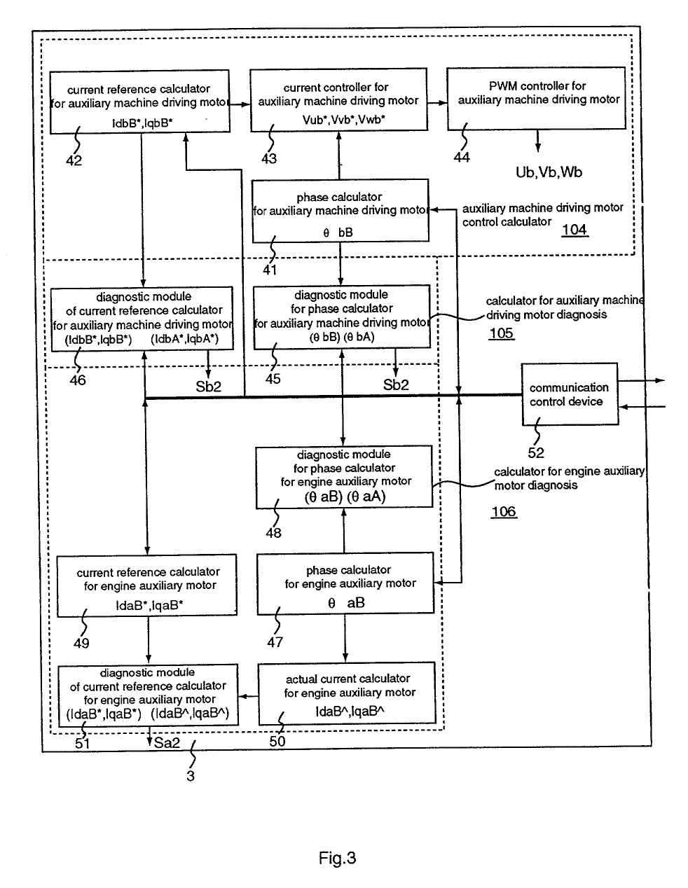

FIG. 3 is a block diagram showing the outline of the functions processed by the program of the microcomputer 3. the microcomputer 3 is also equipped with the same functions as the microcomputer 2. Namely, the microcomputer 3 comprises an auxiliary machine driving motor control calculator 104, a calculator for auxiliary machine driving motor diagnosis 105, a calculator for engine auxiliary motor diagnosis 106 and a communication control device 52 for executing communications processing relating to each process.

The auxiliary machine driving motor control calculator 104 comprises a phase calculator 41 for calculating the rotational phase angle (θbB) of the auxiliary machine driving motor, a current reference calculator 42 for carrying out current reference (IdbB*, IqbB*) calculations for the auxiliary engine driving motor, a current controller 43 for carrying out current control calculations for the auxiliary machine motor, and a PWM controller 44 for converting the current reference value to electrical power based on results of calculations of the current control device for outputting to the power converting device 10B.

The calculator for auxiliary machine driving motor diagnosis 105 comprises a diagnostic module for phase calculator 45 relating to calculations for the auxiliary machine driving motor and a diagnostic module of current reference calculator 46 relating to current reference calculations for the auxiliary driving motor.

The calculator for engine auxiliary motor diagnosis 106 comprises a phase calculator 47 for calculating the rotational phase angle (θaB) of the engine auxiliary motor, a diagnostic module for phase calculator 48 relating to calculations of the engine auxiliary motor phase angle, a current reference calculator 49 for carrying out current reference (IdaB*, IqaB*) for the engine auxiliary motor, an actual current calculator 50 for calculating the actual current (IdaB*, IqaB*) for the auxiliary machine driving motor, and a diagnostic module of current reference calculator 51 relating to the actual current of the auxiliary driving motor current reference.

As the contents of the control occurring at the microcomputer 2 and the contents of the control occurring at the microcomputer 3 are correspondingly analogous, in the following, a description is given principally of the operation of the microcomputer 2, and description of the contents of the control occurring at the microcomputer 3 is omitted, with the exception of characteristic portions.

The microcomputers for the microcomputer 2 and the microcomputer 3 are both capable of writing data to the memory of the other and reading data from the other. As a result, the microcomputer 2 and the microcomputer 3 can each diagnose functions of both themselves and the other and carry out fault diagnosis processing for detecting faults.

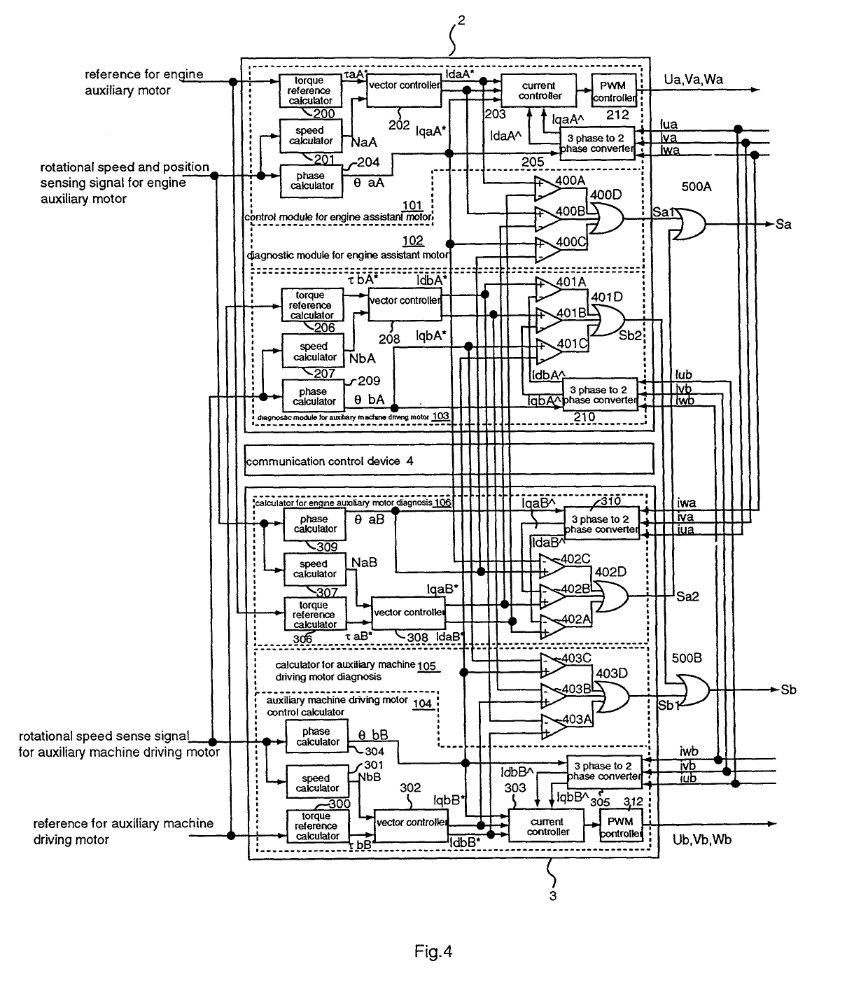

Each of the functions shown in FIG. 2 and FIG. 3 are described in detail using FIG. 4 onwards. FIG. 4 is a view showing the details of the processing contents of the microcomputer 2 and the microcomputer 3 within the electric car control equipment 1 of the basic configuration view shown in FIG. 1.

At the control module 101 for the engine assistant motor of the microcomputer 2, a torque reference (θaA*) is calculated at the torque reference calculator 200 based on the operating reference for engine auxiliary motor use from the supervisor controller 7. Further, a rotational speed (NaA) is calculated at the speed calculator 201 based on a rotational sense signal from the rotation sensor 13A of the engine auxiliary motor. The calculated torque reference (τaA*) and the rotational speed (NaA) are then transmitted to a vector controller 202. At the vector controller 202, a current reference value (IdaA*, IqaA*) to be supplied to the engine assistant motor 12A is calculated based on the values of the torque reference (τaA*) and the rotational speed (NaA). The calculated current reference values (IdaA*, IqaA*) are then transmitted to the current controller 203.

On the other hand, at the phase calculator 204, the rotational phase of the engine assistant motor 12A is calculated from the rotation sense signal of the rotation sensor 13A and the phase angle (θaA) is calculated. Further, at a 3 phase to 2 phase converter 205, the three-phase current (iua, iva, iwa) of the engine assistant motor 12A sensed by the current sensor 14A is taken in, A/D converted, and converted from 3 phase to 2 phase using the phase angle (θaA).

The real current values (IdaAˆ , IqaAˆ ) of the engine assistant motor 12A obtained in this way are then transmitted to the current controller 203. The rotational phase (θaA) is also inputted to the current controller 203 and alternating current voltage reference values (Vua*, Vva*, Vwa*) are calculated based on the real current values. Arithmetic processing for conversion to a PWM signal is then carried out at the 3 phase to 2 phase converter 212 based on the calculated voltage reference value and the results are outputted to the power converting device 10A.

At the diagnostic module 103 for the auxiliary machine driving motor, the a torque reference (τbA) is calculated at a torque reference calculator 206 in response to an operating reference for use with the auxiliary machine driving motor from the supervisor controller 7. At a speed calculator 207, the rotational speed (NbA) is calculated on the basis of the rotational sense signal from the rotation sensor 13B. The calculated torque reference (τbA*) and the rotational speed (NbA) are transmitted to the vector controller 208. Current reference values (IdbA*, IqbA*) to be supplied to the engine assistant motor 12A are then calculated at the vector controller 208 based on the values for the torque reference (rbA*) and the rotational velocity (NbA).

Further, at the phase calculator 209, the rotational phase of the auxiliary machine motor 12B is calculated based on the rotational sense signal of the rotation sensor 13B and the phase angle (θbA) is calculated. Further, at a 3 phase to 2 phase converter 210, the three-phase current (iub, ivb, iwb) of the auxiliary machine motor 12B sensed at the current sensor 14B is taken in, A/D converted, converted from 3 phase to 2 phase using the phase angle (τbA) and the actual current value (IdbAˆ , AqbAˆ ) of the auxiliary machine motor 12B is calculated.

At the auxiliary machine driving motor control calculator 104 of the microcomputer 3, a torque reference (τbB*) is calculated at a torque reference calculator 300 based on an operating reference for auxiliary machine driving motor use from the supervisor controller 7. Further, the rotational speed (NbB) is calculated at the speed calculator 301 from the rotation sense signal from the rotation sensor 13B. The calculated torque reference (τbB*) and the rotational speed (NbB) are then supplied to the vector controller 302. At the vector controller 302, current reference values (IdbB*, IqbB*) to be supplied to the auxiliary machine motor 12B are calculated based on the values of the torque reference (τbB*) and the rotational speed (NbB). The calculated current reference values (IdbB*, IqbB*) are then transmitted to the current controller 303.

At the phase calculator 304, the rotational phase of the auxiliary machine motor 12B is calculated based on the rotation sense signal of the rotation sensor 13B and the phase angle (θbB) is calculated. At the 3 phase to 2 phase converter 305, the three phase current (iub, ivb, iwb) of the auxiliary machine motor 12B sensed by the current sensor 14B is taken in, AID converted, and converted from 3 phase to 2 phase converted using the phase angle (θbB).

The actual current values (IdbBˆ , IqbBˆ ) of the auxiliary machine motor 12B obtained in this way are then transmitted to the current controller 303. The rotational phase (θbB) is also inputted to the current controller 303 and the alternating current voltage reference values (Vub*, Vvb*, Vwb*) are calculated based on these values. Arithmetic processing to convert to a PWM signal is then carried out at a PWM controller 312 based on this calculated voltage reference value and the results are outputted to the power converting device 10B.

At the calculator for engine auxiliary motor diagnosis 106, a torque reference (τaB*) is calculated at the torque reference calculator 306 based on the operating reference for engine auxiliary motor use from the supervisor controller 7. Further, the rotational speed (NaB) is calculated at the speed calculator 307 from the rotation sense signal from the rotation sensor 13A. The calculated torque reference (τaB*) and the rotational speed (NaB) are then transmitted to the vector controller 308. At the vector controller 308, the current reference values (IdaB*, IqaB*) to be supplied to the engine assistant motor 12A are calculated based on the values for the torque reference (τaB*) and the rotational speed (NaB).

The rotational phase of the engine assistant motor 12A is calculated at the phase calculator 309 based on the rotation sense signal of the rotation sensor 13A and the phase angle (θaB) is calculated. At the 3 phase to 2 phase converter 310, the three phase currents (iua, iva, iwa) of the engine assistant motor 12A sensed at the current sensor 14A, A/D converted, 3 phase to 2 phase converted using the phase angle (θaB), and the actual current values (IdaBˆ , IqaBˆ ) of the engine assistant motor 12A is calculated.

Next, a description is given of the diagnosis processing occurring at the microcomputer 2 and the microcomputer 3.

The current reference (IdaA*) calculated at the control module 101 for the engine assistant motor of the microcomputer 2 is inputted to a comparator 400A of the diagnostic module 102 for the engine assistant motor, the current reference (IqaA*) is inputted to a comparator 400B and the phase angle (θaA) is inputted to a comparator 400C.

The current references (IdaB*, IqaB*) calculated at the calculator for engine auxiliary motor diagnosis 106 of the microcomputer 3 and the phase angle (θaB) are transmitted to the microcomputer 2 by the communication control device 4 provided between the microcomputer 2 and the microcomputer 3. The current reference (IdaB*) is inputted to the comparator 400A of the diagnostic module 102 for the engine assistant motor and the phase angle (θaB) is inputted to the comparator 400C.

The current reference (IdbA*) calculated at the diagnostic module 103 for the auxiliary machine driving motor of the microcomputer 2 and the actual current value (IdbAˆ ) are inputted to a comparator 401A. The current reference (IqbA*) and the actual current value (IqbAˆ ) are inputted to a comparator 401B and the phase angle (θbA) is inputted to a comparator 401C. The phase angle (θbB) calculated at the diagnostic module 103 for the auxiliary machine driving motor of the microcomputer 3 is inputted to the comparator 401C via the communication control device 4.

The current reference (IdbB*) calculated at the auxiliary machine driving motor control calculator 104 of the microcomputer 3 is inputted to a comparator 403A of the calculator for auxiliary machine driving motor diagnosis 105, the current reference (IqbB*) is inputted to a comparator 403B and the phase angle (θbB) is inputted to a comparator 403C.

On the other hand, the current reference (IdbA*, IqbA*) calculated at the diagnostic module 103 for the auxiliary machine driving motor of the microcomputer 2 and the phase angle (θbA) are transmitted to the microcomputer 3 by the communication control device 4 provided between the microcomputer 2 and the microcomputer 3. The current reference (IdbA*) is inputted to the comparator 403A of the calculator for auxiliary machine driving motor diagnosis 105, current reference (IqbA*) is inputted to the comparator 403B and the phase angle (θbA) is inputted to the comparator 403C.

The current reference (IdaB*) calculated at the calculator for engine auxiliary motor diagnosis 106 of the microcomputer 3 and the actual current value (IdaBˆ ) are inputted to a comparator 402, the current reference (IqaB*) and the actual current value (IqaBˆ ) are inputted to a comparator 402B, and the phase angle (θaB) is inputted to a comparator 402C. Further, the phase angle (θaA) calculated at the control module 101 for the engine assistant motor of the microcomputer 2 is inputted to the comparator 402C of the calculator for engine auxiliary motor diagnosis 106 via the communication control device 4.

At the diagnostic module 102 for the engine assistant motor of the microcomputer 2, when the results of the comparisons at the comparators 400A, 400B and 400C and the differences obtained by the respective comparators are greater than or equal to a certain threshold value, a comparison fault signal Sa1 is outputted at an OR circuit 400D.

At the diagnostic module 102 for the engine assistant motor of the diagnostic module 103 for the auxiliary machine driving motor, when the results of the comparisons at the comparators 401A, 401B and 401C and the differences obtained by the respective comparators exceed a certain threshold value, a comparison abnormal signal Sb2 is outputted at the OR circuit 400D.

Similarly, when the results of comparisons at comparators at each of the calculators 105 and 106 of the microcomputer 3 or the differences obtained at each of the comparators are greater than or equal to a certain threshold value, each of the abnormal signals Sb1 and Sb2 are outputted at OR circuits 403D and 402D.

Output signals Sa1 and Sa2 of OR circuits 400D and 402D are inputted to OR circuit 500A arranged outside of the microcomputer 2 and the logical sums of these signals are outputted as interrupt signals Sa.

Similarly, output signals Sb1 and Sb2 of OR circuits 401D and 403D are inputted to OR circuit 500B arranged outside of the microcomputer 3 and the logical sums of these signals are outputted as interrupt signals Sb.

With the above configuration, when an abnormality occurs at either the microcomputer 2 or the microcomputer 3, an abnormal computer or sensor can be determined by comparing control data for current reference values etc. calculated at each microcomputer and actual data and operation of the controller 1 for the electric car can be halted in a reliable and rapid manner.

Further, when abnormalities occur at any of the power converting devices 10A and 10B, the engine assistant motor 12A, the auxiliary machine motor 12B or the current sensor 14A or 14B, abnormalities can be sensed by comparing current reference values for diagnosis using the calculators for diagnosis use of each of the microcomputers and the real current values and the operation of the controller 1 for the electric car can be halted in a reliable and rapid manner.

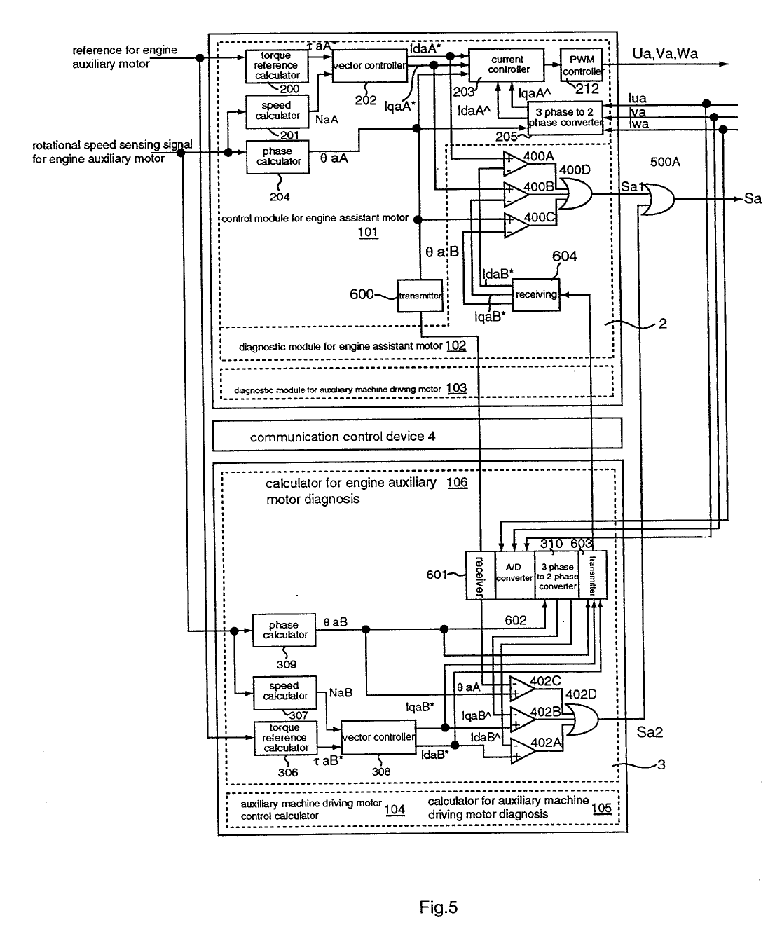

FIG. 5 is a functional block diagram taking note of only processing for the engine auxiliary motor occurring in the processing contents of the microcomputer 2 and the microcomputer 3 within the electric car control equipment 1 constituting a second embodiment of the present invention, with portions that are the same as portions for the embodiment shown in FIG. 4 being given the same numerals.

In the second embodiment shown in FIG. 5, the phase angle (θaA) of the control module 101 for the engine assistant motor of the microcomputer 2 calculated at a phase calculator 204 is transmitted by a transmitter 600. The transmitter 600 transmits the phase angle (θaA) to the communication control device 4. When the phase angle (θaA) from the transmitter 600 is received at the communication control device 4, an operation is carried out to notify the microcomputer 3 of the occurrence of a receival.

At the microcomputer 3, when notification of the occurrence of a receival from the communication control device 4 is received by a receiver 601, data for the phase angle (θaA) is taken in.

The phase angle (θaA) taken in by the receiver 601 is then transmitted to the comparator 402 of the calculator for engine auxiliary motor diagnosis 106. At the calculator for engine auxiliary motor diagnosis 106, after the phase angle (θaA) is taken in by the receiver 601, processing is carried out by an A/D converter 602 to convert the current sense signals (iua, iva, iwa) to digital signals. The converted current sense signals (iua, iva, iwa) are then converted by a 3 phase to 2 phase converter 310 and actual current values (IdaBˆ , IqaBˆ ) are outputted and transmitted to comparators 402A and 402B.

When the processing at the 3 phase to 2 phase converter 310 finishes, the current reference values (IdaB*, IqaB*) and the phase angle (θaB) are taken in at a transmitter 603 are and transmitted to the communication control device 4. The communication control device 4 then notifies the microcomputer 2 when data for the current reference values (IdaB*, IqaB*) and the phase angle (θaB) is received.

In response to the notification, the microcomputer 2 receives the current reference values (IdaB*, IqaB*) and the phase angle (θaB) via a receiver 604 from the communication control device 4 and transmits them to the comparators 400A, 400B and 400C of the diagnostic module 102 for the engine assistant motor.

Send and receive signal processing for the microcomputer for the engine assistant motor 2 and the microcomputer 3 is carried out periodically and processing at the time of notification of the occurrence of receipt of a signal from the communication control device 4 at the receiving side microcomputer can be carried out using interrupt processing.

Data reception is carried out only when necessary by placing the receiver 601 and the receiver 604 in interrupt processing and the load placed on the software can therefore be alleviated. Further, notification of original reception can be given to the other microcomputer without using the software of the microcomputer by providing means for generating an interrupt signal electrically when data is written to the communication control device 4 and the load placed on the software can therefore be further alleviated.

With this kind of configuration, even if the vector controller 202 and 308 etc. within the microcomputer 2 and the microcomputer 3 do not always operate in synchronism, transmission and receival of calculated data can always be carried out in synchronism and the transmission and receiving of data is reliable.

It is also possible to utilize that having bidirectional communication memory such as dual port RAM etc. as the communication control device 4.

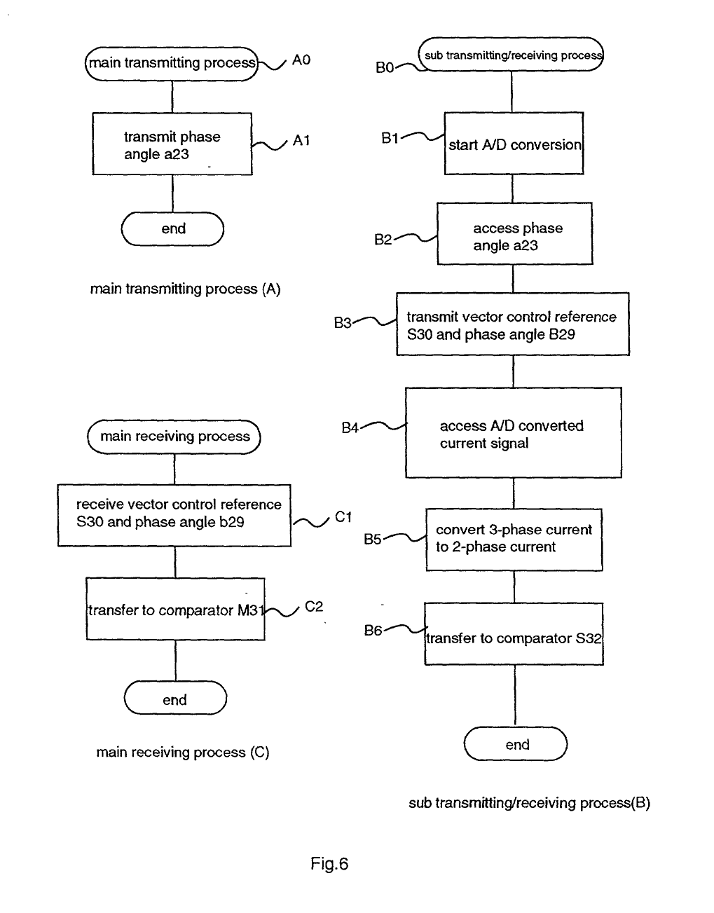

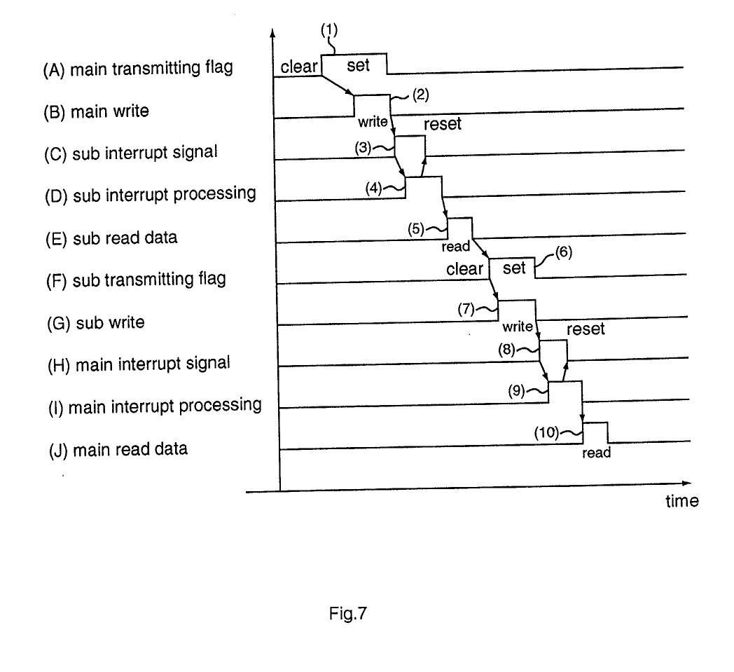

FIG. 6 is a flowchart showing the details of a data transmission processing and data receiving processing operation employing the communication control device 4 by the microcomputer 2 (main side) and the microcomputer 3 (sub side). FIG. 7 is a flowchart showing a data transmission and receiving sequence by the communication control device 4.

In FIG. 6(A), a main transmitting process is carried out each certain arbitrary period at the microcomputer 2 and in step A1 the phase angle (θaA) is transmitted to the communication control device 4. At the communication control device 4, the microcomputer 3 is notified of the occurrence of a receival.

Next, in FIG. 6(B), execution of a sub transmitting/receiving process is carried out at the microcomputer 3. First, in step B1, analog to digital conversion is started. If the analog to digital conversion has started, in step B2, the phase angle (θaA) transmitted from the microcomputer 2 via the communication control device 4 is taken in.

If the phase angle has been taken in in step B2, in step B3, a current sense signal present in results of the analog to digital conversion that was just started in step B1 is taken in. Next, in step B4, conversion of the current sense value by the current conversion means is carried out based on the values of the just received phase angle and the current sense signal and a vector current sensing value is calculated. Next, in step B5, results calculated in step B4 are transmitted to the comparators 402A, 402B and 402C of the calculator 106 for engine auxiliary motor diagnosis 106.

In step B6, the vector control reference and phase angle within the microcomputer 3 are transmitted to the communication control device 4.

In FIG. 6(C), the main receiving process is started and in step C1, the vector control reference and the phase angle are received via the communication control device 4. Next, in step C2, the received vector control reference and the phased angle are transmitted to comparators 400A, 400B and 400C of the diagnostic module 102 for the engine assistant motor.

FIG. 7 is a flowchart showing the sequence for transmitting and receiving data using the communication control device 4. When the first transmission corresponding to the main transmitting process of FIG. 6(A) starts, as shown in FIG. 7(A), the main transmitting flag is set within the microcomputer 2 is set at a timing (1). After this, as shown in FIG. 7(B), the microcomputer 2 writes data to be transmitted to the communication control device 4 at a timing (2).

When writing of the data to be transmitted is complete, as shown in FIG. 7(C), the communication control device 4 generates a signal at the at the timing (3) and the microcomputer 3 is notified of the presence of receive data. Then, in a manner corresponding to the sub transmitting/receiving processing of FIG. 6(B), at FIG. 7(D), the microcomputer 3 receives the interrupt signal and a receive interrupt process is started at a timing (4). After starting of the interrupt process, as shown in FIG. 7(E), the microcomputer 3 reads data from the communication control device 4 at a timing (5), i.e. an operation for receiving data from the microcomputer 2 is carried out.

Next, as shown in FIG. 7(F), a flag is set in order for the microcomputer 3 to transmit data at a timing (6) upon the microcomputer 3 concluding receival of the data. Next, in response to the main receiving process of (C) of FIG. 6, as shown in (G) of FIG. 7, the microcomputer 3 writes data to the communication control device 4 in order to send data from the microcomputer 3 to the microcomputer 2 at a timing (7).

When the microcomputer 3 finishes writing data to the communication control device 4 at a timing (7), as shown in (H) of FIG. 7, the communication control device 4 notifies the microcomputer 2 of an interrupt signal at a timing (8).

Next, as shown in (I) of FIG. 7, the microcomputer 2 receives the interrupt signal and an interrupt process is started at a timing (9). After the interrupt process, as shown in FIG. 7(J), data is received from the communication control device 4 at a timing (10), i.e. data from the microcomputer 3 is received by the microcomputer 2.

By adopting this kind of configuration, data used for comparisons at the microcomputer 2 and the microcomputer 3 are synchronized and updated so that data updated during comparisons is updated at a synchronized timing and the comparative precision is raised.

In the sub transmitting/receiving process, by processing start of execution of analog/digital conversion and the taking in of conversion results in separate processing procedures, transmitting and receiving of data is carried out during the time for carrying out analog/digital conversion, redundancy in the software processing time is removed and the load placed on the software is alleviated.

By gathering all of the data required in calculating the real current values together in the sub transmitting/receiving processing, sensing of abnormalities -for the whole of control equipment for other than that required in calculations can be achieved. At this time, by carrying out transmitting/receiving of data for the current sense values in synchronism, sensing can be carried out with few errors in the current reference values and current sense values and the comparative sensing performance can be improved.

As described above, by providing a communication control device between a plurality of microcomputers (control means) and carrying out transmitting and receiving of control data, abnormalities in the communication control device of an electric car can be sensed by comparing data transmitted and received at each of the microcomputers internally. At this time, when data is transmitted from a transmission side microcomputer to the communication control device, transmitting and receiving of data can be carried out in synchronism even when each microcomputer is not operating in synchronism with each other by having the receive side microcomputer generate an interrupt. By transmitting and receiving a current reference value referencing a current flowing in an electric motor, a current sense value sensing current flowing in an electric motor and a phase angle of the electric motor for converting the current sense value as transmitting and receiving data and then carrying out comparisons within each microcomputer, abnormalities in the entire control equipment outside of the calculations of the microcomputers can be sensed by comparing and making determinations from the current reference value and the current sense value even when there are no abnormalities in the reference values.

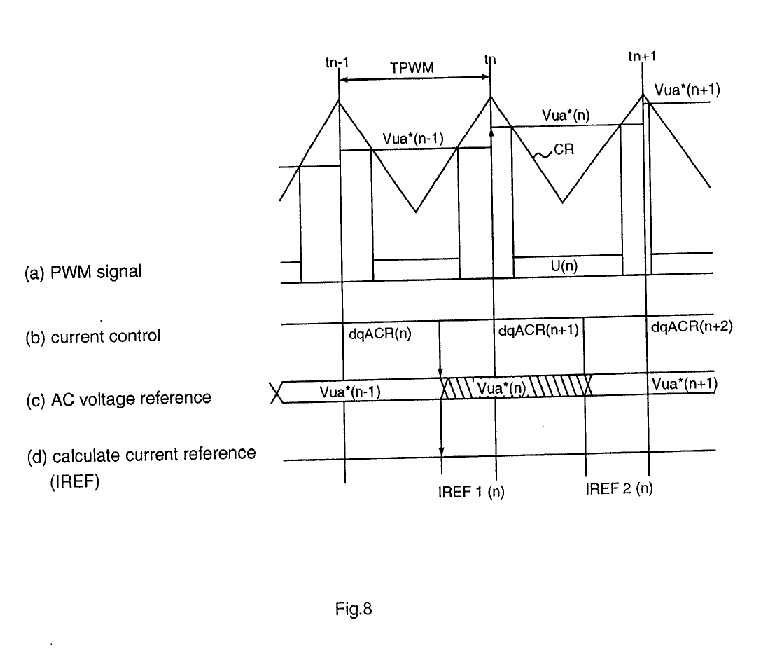

It is therefore possible to bring about control equipment for an electric car capable of sensing abnormalities in control equipment with a high degree of precision while maintaining a simple configuration. the microcomputer 2 of the present invention carries out processing using the periods shown in FIG. 8. (The same can also be said for the microcomputer 3).

First, a triangular carrier wave as shown by CR of FIG. 8(a) is generated within the PWM controller 44 and a PWM signal is generated by making comparisons with alternating current voltage reference values Vua*, Vva*, Vwa* calculated at the current controller 23. With the processing at the current controller 23, the process dqACR for the current controller shown in FIG. 8(b) is executed every switching period Tpwm of a power element of the power converting device 10A, where Tpwm=100 mps when the switching frequency is, for example, 10 KHz. Then, as shown in FIG. 8(C), Vua*(n) calculated at dqACR(n) at the point in time n is set at the PWM controller 24 and a PWM signal U(n) is generated.

In a process IREF(n) of the current reference calculator 22 for calculating the current reference values Id* and Iq* required to execute processing for the current controller 23, as shown in FIG. 8(D), after the processing of the current controller, one process is divided into IREF1(n) and IREF2(n) and executed in a period longer than the processing period for the current controller 23. A fault diagnosis process occurring at the microcomputer 2 and the microcomputer 3 is also executed in a period longer than the processing period of the current controller.

The current reference calculator 22 sets it's period depending on the drivability of the vehicle, e.g. a period of a number of milliseconds, in order to achieve a target torque response in accordance with a torque reference value calculated by the torque reference generator and executed in 10 milliseconds. The same is also the case for the fault diagnosis process.

Further, as rotational speed (N)=120×f/P (number of poles) when viewed from the motor side, in the case of a synchronous motor with eight poles, taking the maximum rotational speed required to be 15760 revs per minute, then Hz=15760×8/120=1050 (Hz). This gives high frequency control of 1 KHz or more exceeding the frequency region for general commercial use of (50 Hz) and a high frequency inverter can be used.

By dividing each of the means of the communication control device of the present invention described above between a switching period of the power converting device and a period depending on the dynamic characteristics etc. of a driver, processing is possible with just one device and control equipment for generating drive signals for power elements of power converters for supplying electric power to alternating current motors for driving an electric car can be made small, lightweight and more reliable.

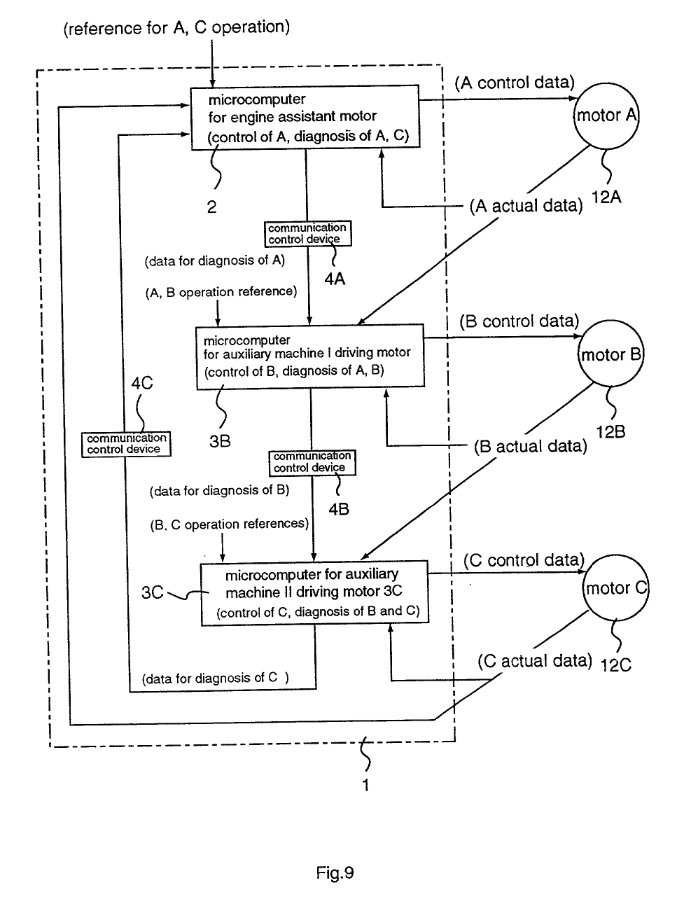

The present invention can be applied even when there are three or more microcomputers for individually controlling each rotating machine are provided as control apparatus for an electric car. An example is shown in FIG. 9. The microcomputer 2 is provided with a function for generating control data for controlling the engine assistant motor 12A, a function for transmitting the control data to a microcomputer 3B for a driving motor for an auxiliary machine I via a communication control device 4A equipped with bidirectional communication memory as control data for diagnosis use, a function for comparing the control data and real data for the engine assistant motor (A) 12A and diagnosing the presence or absence of faults for the microcomputer 2, and a function for utilizing control data for analysis use of a microcomputer 3C for the driving motor for the auxiliary machine II generated at the microcomputer for auxiliary machine II driving motor 3C received via a communication control device 4C for carrying out diagnosis of the microcomputer for auxiliary machine II driving motor 3C.

Similarly, the microcomputer 3B for the driving motor for the auxiliary machine I is provided with a function for generating control data for controlling the auxiliary machine motor B (12B), a function for transmitting the control data to the microcomputer for auxiliary machine II driving motor 3C via a communication control device 4B equipped with bidirectional communication memory as control data for diagnosis use, a function for comparing the control data, real data for the auxiliary machine motor B (12B) and the control data for diagnosis use and diagnosing the presence or absence of faults in the microcomputer 3B for the driving motor for the auxiliary machine I, and a function for utilizing control data for use in analysis of A and generated at the microcomputer 2 and received via the communication control device 4A and real data to carry out diagnosis of the microcomputer 2.

Further, the microcomputer for auxiliary machine II driving motor 3C is provided with a function for generating control data for controlling the auxiliary machine motor C (12C), a function for transmitting the control data to the microcomputer 2 via a communication control device 4C equipped with bidirectional communication memory as control data for use in diagnosis of C, a function for comparing the control data, real data and the control data for diagnosis use and diagnosing the presence or absence of faults in the microcomputer for auxiliary machine II driving motor 3C, and a function for utilizing control data for use in analysis of B generated at the microcomputer 3B for the driving motor for the auxiliary machine I and received via the communication control device 4B and real data to carry out diagnosis of the microcomputer 3B for the driving motor for the auxiliary machine I. These diagnosis processes are executed at the timing shown in FIG. 8(d).

In this embodiment also, as in the aforementioned embodiment, the transmission and receive processing for the microcomputer 2, microcomputer for auxiliary machine driving motor 3 and microcomputer for auxiliary machine II driving motor 3C is carried out periodically and the processing at the time of at the time of notification of the data reception from the communication control devices 4A, 4B and 4C equipped with bidirectional memory to the receive side microcomputer is carried out using an interrupt process. With this configuration, transmitting and receiving of calculated data can always be carried out in synchronism even if the vector controllers etc. within the microcomputer 2, microcomputer 3B for the driving motor for the auxiliary machine I and microcomputer for auxiliary machine II driving motor 3C are not always operating in synchronism and the transmitting and receiving of data can be made reliable.

In this way, even if three or more microcomputers for individually controlling each rotary machine are provided, each microcomputer can carry out mutual diagnosis by utilizing the remaining two microcomputers and the overall processing does not become complex.

According to the present invention, control equipment for an electric car mounted with a plurality of rotating machines and being equipped with microcomputers for individually controlling each of the rotating machines and a control method thereof capable of diagnosing abnormalities in control equipment with a high degree of precision can be realized using a simple configuration without increases in costs.

What is claimed is:

1. Control equipment for an electric car mounted with a plurality of rotating machines and being equipped with microcomputers for individually controlling each said rotating machine, each said microcomputer comprising: control data calculating means for generating control data for controlling each respective rotating machine to be controlled; and fault diagnosis means for transmitting and receiving said control data to and from another microcomputer as control data for diagnosis use via communication means, comparing said control data and said control data for diagnosis use, and diagnosing the presence or absence of a fault.

2. Control equipment for an electric car mounted with a plurality of rotating machines and being equipped with microcomputers for individually controlling each said rotating machine, each said microcomputer comprising: a plurality of control data calculating means for generating control data for controlling each respective rotating machine to be controlled and generating data for controlling rotating machines to be controlled by another microcomputer as control data for diagnosis use; communication control means for transmitting an interrupt signal to any of said plurality of control data calculating means and carrying out data communication between said plurality of control data calculating means via communication means; and fault diagnosis means for comparing said control data generated by each microcomputer with said control data for diagnosis generated by said other microcomputer and diagnosing the presence or absence of a fault, wherein said plurality of control data calculating means transmit and receive said control data for diagnosis use in synchronism with said interrupt signal.

3. Control equipment for an electric car mounted with a plurality of rotating machines and being equipped with microcomputers for controlling each said rotating machine, each microcomputer for controlling said each rotating machine comprising: a plurality of control data calculating means for generating control data for controlling each respective rotating machine to be controlled in response to an operating reference; communication control means for transmitting an interrupt signal to any of said plurality of control data calculating means and carrying out data communication between said plurality of control data calculating means via communication means; first fault diagnosis means for generating control data for controlling said rotating machines not to be controlled in response to an operating reference as control data for diagnosis use for comparing with an actual current value of a rotating machine not to be controlled in such a manner as to diagnose the presence or absence of a fault; and second fault diagnosis means for comparing control data of rotating machine to be controlled and control data for diagnosis use of a rotating machine to be controlled generated by another microcomputer in such a manner as to diagnose the presence or absence of a fault, wherein said plurality of control data calculating means transmit and receive said control data for diagnosis use in synchronism with said interrupt signal.

4. The control equipment for an electric car of any one of claims 1 to 3, wherein process timing of said control data calculating means is divided between a switching period of electrical power conversion means connected across each said rotating machine and a power supply and a period depending on dynamic characteristics of an electric car driver.

5. The control equipment for an electric car of any one of claims 1 to 3, wherein said transmitted and received control data for diagnosis use is a current reference value for current flowing at said rotating machine, a current sense value for current flowing at said rotating machine and a phase angle of said rotating machine.

6. The control equipment for an electric car of either of claims 4 or 5, wherein said communication means is equipped with bi-directional communication memory.

7. The control equipment for an electric car of claim 6, wherein said rotating machine includes an engine auxiliary motor for driving drive wheels of an electric car and an auxiliary machine driving motor for driving an auxiliary machine.

8. The control equipment for an electric car of claim 5, wherein said rotating machine is a three-phase alternating current motor or a three-phase alternating current generator and said current reference value and said current sense value are values coordinate converted from three-phase alternating current to two-phase alternating current.

9. A method for controlling an electric car mounted with a plurality of rotating machine and equipped with microcomputers for individually controlling each said rotating machine, with each said microcomputer having control data calculating means, communication means and fault diagnosis means, wherein: at each said control data calculating means, control data for controlling target rotating machines is generated and data for controlling rotating machines of control targets of another microcomputer is generated as control data for diagnosis use; an interrupt signal is transmitted to any of said plurality of control data calculating means, and data communication between said plurality of control data calculating means via said communication means; is controlled by said communication means, said control data generated by each said microcomputer is compared with said control data for diagnosis use generated by said other microcomputer, and the presence or absence of a fault is diagnosed by said fault diagnosis means; and, in synchronism with said interrupt signal. at said plurality of control data calculating means, transmitting and receiving of said control data or said control data for diagnosis use is carried out.

10. The method of claim 9, wherein said plurality of control means perform control in a switching period of an electrical power conversion device connected across each said rotating machine and a power supply and a period depending on dynamic characteristics of an electric car driver.
